(19) United States
(12) Patent Application Publication
(10) Pub. No.: US 2024/0343960 A1
(43) Pub. Date: Oct. 17, 2024

(54) RECOVERABLE IMPREGNATION SEALANT

(71) Applicant: Godfrey & Wing, LLC, Aurora, OH (US)

(72) Inventors: Xiaoming Wu, Aurora, OH (US); Rachel Guest, Aurora, OH (US)

(21) Appl. No.: 18/628,986

(22) Filed: Apr. 8, 2024

Related U.S. Application Data
(60) Provisional application No. 63/459,532, filed on Apr. 14, 2023.

(51) Int. Cl. C09K 3/10

(52) U.S. Cl. CPC C09K 3/1006; C09K 2003/1034

(57) ABSTRACT

A sealant for use in vacuum pressure impregnation, wherein the sealant includes at least one monomer that is at least partially hydrophilic, at least one monomer that is at least partially hydrophobic, and wherein the sealant has a density less than the density of water.

### CROSS-REFERENCE TO RELATED APPLICATIONS

This application claims priority to and incorporates by reference U.S. Provisional Application No. 63/459,532 filed on Apr. 14, 2023.

### FIELD OF THE INVENTION

The present invention relates to vacuum pressure impregnation (VPI) sealants that are separable from water.

### BACKGROUND

The porosity of metal parts and graphite parts, which can result in leakage and fail hermetic requirements, can be sealed through sealant impregnation processes. Impregnation sealants are typically forced into the porosity of parts by vacuum and pressure. A vacuum (dry vacuum) removes air from the porosity of a part to be impregnated. The part is then immersed into liquid sealant under vacuum (wet vacuum). The wet vacuum causes the sealant to wick into the porosity and exchange out the residual air in the porosity. Then the sealant is pushed into the porosity under pressure, which can be ambient pressure or an elevated pressure such as 75 psi. After impregnation with the liquid sealant, excess liquid sealant on the outer surface of the part is usually removed by washing (and/or rinsing) the part with water. This can be done in any suitable manner, such as in an agitated water bath or by incorporating a rinse zone by centrifugation.

The impregnated and washed and/or rinsed parts are then transferred to a curing chamber in which the liquid sealant in the pores of the part is cured into a solid material to seal the porosity. This sealant may be cured in any manner such as heat cure or self-cure without heat.

For fast impregnation, low viscosity sealants, such as acrylic sealants, are used because they more readily pass into and fill the porosity. Acrylic sealants also possess somewhat good water solubility or miscibility causing the sealant washed off the part surface to be dissolved or dispersed into the water. To help wash (or rinse) the liquid sealant from the outer surface of an impregnated part, an organic solvent or surfactant could be added to water as a cleaning aid. Liquid sealant accumulates in the wash or rinse water over time. That lowers the ability of the water to continue removing liquid sealant from parts. So, frequent water changing may be required. The amount of water usage related to the wash and/or rinse process and the replacement of water can be a challenge, particularly in an area with scarce water supplies. Also, the disposal of water contaminated by liquid sealant is regulated and costly. For environmental purposes and process economy, it would be preferred to remove the liquid sealant from wash/rinse water (1) so the water includes less sealant and will conform to environmental regulations, thus allowing for inexpensive disposal, and (2) if liquid sealant is properly extracted from the water, it can be reused.

One approach to separate sealant from wash or rinse water is to increase the specific gravity of the water by the addition of salt. This causes excess liquid sealant that is less dense than the salinated water to float to the top. Additionally, it has been proposed to develop a liquid sealant that is denser than water. In that case, sealant in wash or rinse water would sink to the bottom of a water tank. However, such a method would still be inefficient because removing sealant from the bottom of a water tank is difficult.

Accordingly, it would be desirable to provide an impregnation sealant that readily separates from water and floats to the top of water in a vessel.

### SUMMARY

Recoverable sealants as described in this disclosure are formulated to preferably have a density lower than the density of water. A lower-density liquid sealant according to this disclosure floats to the top of water in a vessel such as a holding tank. This facilitates recovery of the liquid sealant. Such a lower-density liquid sealant preferably includes one or more at least partially hydrophobic monomers and one or more at least partially hydrophilic monomers. After being recovered, the liquid sealant can preferably be returned to the liquid sealant reservoir for use in future process cycles of impregnating parts. This permits one or more of (1) sealant to be reused, (2) less sealant loss, and (3) a reduction in the amount of sealant in disposed wash or rinse water. A liquid sealant of this disclosure can reduce costs because of one or more of the following (1) less overall sealant is used in a sealant impregnation facility, (2) a longer lifetime of rinse/wash water is realized, and (3) the disposed rinse/wash water includes relatively minor amounts of sealant and can be inexpensively disposed because the disposed water will meet at least some environmental regulations.

As used in this specification, “washed,” “wash,” “rinsed,” “wash/rinse,” “rinse/wash,” and “rinse” refer to (1) washing a part with water and surfactant or solvent, (2) rinsing a part using just water, and (3) both washing and rinsing. The Department of Defense Design Certain Impregnation of Porous Metal Castings and Powdered Metal Components MIL-STD-276A, Dec. 20, 1992, is incorporated herein by reference.

### DETAILED DESCRIPTION

The liquid sealants of this disclosure are used for sealing porous parts, wherein the liquid sealant has improved water separability because of the inclusion of (1) one or more of at least partially hydrophobic monomers that make the liquid sealant less dense than water and cause the liquid sealant to separate from water, and (2) one or more at least partially hydrophilic monomers, which lead to improved rinse/wash water treatability of the liquid sealant because the liquid sealant is partially miscible or soluble in water. A liquid sealant of this disclosure separates from the rinse/wash water due to the sealant being less dense than water and containing one or more at least partially hydrophobic monomers. The water-soluble or water miscible monomer (i.e., hydrophilic) is carried along with the water insoluble (i.e., hydrophobic) monomer as the liquid sealant separates from the water and floats to the surface.

The recovered liquid sealant could retain some water. The liquid sealant's polarity could be altered by combination of different ingredients which possess different polarities to limit, but not eliminate, water-uptake in the rinse/wash process. An intermediate process, such as heating the recovered sealant to, for example, 30°-40°, has shown the ability to remove water from recovered sealant prior to returning the sealant to the liquid sealant tank for reuse. One method is to use a vacuum 0-6 torr to force the water out of the recovered sealant at room temperature (about 20° C.-25° C.) or a slightly elevated temperature, such as 30° C.-40° C.

### Hydrophobic Monomers

A liquid sealant according to this disclosure may include one or more at least partially hydrophobic monomers including, but not limited to: C₁₂-C₁₄ alkyl methacrylate (lauryl methacrylate or “LMA”), C₁₆-C₁₈ alkyl methacrylate (stearyl methacrylate or “SMA”) and 1, 12-dodecanediol dimethacrylate (“C₁₂DMA”). LMA has a density of about 0.87 of the density of water, SMA has a density of about 0.86 of the density of water, and C₁₂DMA has a density of about 0.95 of the density of water.

### Hydrophilic Monomers

The liquid sealant also includes one or more at least partially hydrophilic monomers including, but not limited to, diethyleneglycol dimethacrylate (DEGDMA), triethyleneglycol dimethacrylate (TEGDMA), trimethylolpropane ethoxylate triacrylate (TMP (EO)₃TA), and trimethylolpropane trimethacrylate (TMPTMA). DEGDMA may have a solubility of 0.58 g/l in water and a density of 1.06 times the density of water, TEGDMA has a solubility of 3.5 g/l in water and a density of 1.07 times the density of water. TMP (EO)₃TA has a solubility of 0.88 g/l in water and a density of 1.12 times the density of water. TMPTMA has a solubility of 0.01 g/l in water and a density of 1.06 times the density of water.

In the liquid sealant composition, the weight ratios of the one or more at least partially hydrophobic monomer(s) to the one or more at least partially hydrophilic monomer(s) may range from 55:45 to 65:35. Regarding the one or more hydrophobic monomer(s), a weight ratio of mono-methacrylate to dimethacrylate, such as LMA (or SMA), to C₁₂DMA may be from 100:0 to 75:25 if such a combination is used.

### Other Monomers and Additives That May Be Included

The liquid sealant may also include bisphenol A based difunctional acrylic monomers such as bisphenol A epoxy diacrylate, bisphenol A (ethoxylated)ₙ diacrylates, n=3, 4, 10, 30, and bisphenol A (ethoxylated)ₙ dimethacrylates, n=3, 4, 10, 30. These monomers have relatively good hydrophilicity and low water solubility. Their use could improve the sealant's washing/rinsing properties and maintain good sealant/water separability. These monomers have low water miscibility and may have a density of about 1.12-1.14 times the density of water. If used, the loadings of these monomers would range from about 2%-10% by weight, more preferably about 4%-8% by weight, or even more preferably about 5%-6% by weight of the liquid sealant.

The liquid sealant may also include about 0.08%-0.15% by weight of bis [2-(methacryloyloxy) ethyl] phosphate, which is a water soluble dimethacrylate monomer. If used, this helps improve the liquid sealant's washability and also improves the liquid sealant's adhesion to the surfaces of metal pores.

The liquid sealant may also include about 0.2%-0.5% by weight of one or more of (a) lauryl ethoxylated acrylate, (b) hexanediol ethoxylated diacrylate, (c) alcohol ethoxylate, or (d) tetracthyleneglycol bis (2-ethylheanoate). These monomers could enhance the overall monomer mixture homogeneity, and consequently the uniform thermal mechanical properties of the cured sealant.

### Some Exemplary Sealant Characteristics

The liquid sealant can be formulated to have different curing mechanisms, such as heat cure at an elevated temperature, anaerobic cure at room temperature or an elevated temperature, or radiation cure with electron beam (e-beam). A liquid sealant of this disclosure may be heat cured, and in one example includes a radical initiator such as azobisisobutyronitrile, which may be VAZO 64. The radical initiator loading could be about 0.25% to 0.30% by weight of the liquid sealant.

Depending on the composition, a recoverable liquid sealant of this disclosure may have a viscosity in a range of 5.0-15.0 cps, and a density in a range of 0.935-0.955 g/cm³. A heat-cured liquid sealant of this disclosure may have a gel time from 2 minutes 30 seconds to 4 minutes 30 seconds in water at 90° C. Such a liquid sealant may be configured to fully cure in about 10 minutes in water or steam at 90° C., or in water or steam in a range between 80° C. to 100° C. After being fully cured, this exemplary sealant may have a hardness of 55-80 Shore D, and a solid density of approximately 1.03 g/cm³.

A liquid sealant of this disclosure separates from rinse/wash water and in one example the liquid sealant separates as follows: in 1 minute, more than 50% of the liquid sealant liquid separates from the water and floats to the surface of the water at 23° C.; in two minutes, 60% of the liquid sealant separates from the water and floats to the surface of the water at 23° C.; in 10 minutes, more than 90% of the liquid sealant separates from the water and floats to the surface of the water at 23° C.; in 2 hours, 98% or more of the liquid sealant separates from and floats to the surface of the water at 23° C. The resulting rinse/wash water of this example had a Brix Index (Bx) of about 0.2 to 0.3. The Bx value is lower than that of the rinse water contaminated by traditional water-soluble sealants, which can be up to ≥1.5 and above most regulatory requirements for water disposal.

Floating liquid sealant can be collected and recovered from the surface of the water, typically using a sealant recovery system (“SRS”) in the field. Because most of the liquid sealant is removed from the water, the rinse/wash water is less contaminated which prolongs the use of rinse/wash water for rinsing/washing without adding more water. This aids in water conservation.

The recovered liquid sealant can preferably be reused five times or more with little loss in curing and sealing properties. To determine reusability, a recovered liquid sealant is monitored by checking its viscosity and curing behaviors. In one example, the recovered liquid sealant would be deemed unsuitable for reuse if it had one or more of the following characteristics: (1) the viscosity is out of the specification range of 5-15 cps at 25° C., (2) the target gel time in water at 90° C. is more than 6 minutes out of the sealant's specification range, and (3) the cured sealant loses its mechanical strength, which in this example is indicated by a hardness of lower than 50 Shore D (as compared to, in this example, a specification range of 55-80 Shore D). If one or more of these parameters is out of the specification range, the recovered sealant is sufficiently contaminated and should be disposed. The specific parameters for determining whether a liquid sealant according to this disclosure may be reused may vary according to the exact sealant formulation and the requirements for a specific part including the specific sealant.

Sealant cured in a part's porosity enhances one or more of a part's density, the part's mechanical properties, such as being less porous, and the part's machinability. A part with cured sealant of this disclosure performs well with chemicals in reference to the U.S. military specification, MIL-I-17563C.

### Sealant Curing Profile Measurement

The curing profile of the sealant is measured by Q20 TA Instruments Differential Scanning calorimetry (DSC) tool or equivalent. This measurement is performed on sealant samples in order to determine exothermic reactions from curing. The tool measures the heat flow of a sealant sample, yielding results which include the change in enthalpy (AH). DSC can quantify the heat released during the reaction, thus providing information about the curing mechanism.

The sealant sample should be run under a nitrogen flow of 50 mL/min. The mass of the sealant added to the pan should be between 10 and 15 mg. To minimize the sealant wicking up the sides of the specimen pan, an embossed graphite plate or flat blank (die punch a 4 mm diameter sample) can be placed at the bottom of the pan to soak up the sealant to allow more contact with the pan and furnace. The sealant sample should be sealed inside DSC pans (hermetic lids are preferred) and then loaded into a DSC chamber.

One exotherm peak suggests that only the desired reaction is occurring. This is generally preferred because the cross-linking reaction is completed in one step.

### Measuring Sealant Viscosity

Sealant viscosity can be measured using a Brookfield viscometer, which will provide a viscosity measure in centipoise (cps). The sealant preferably has a viscosity of 5 cps-15 cps at 25° C. when measured on a 00 spindle. This is for measuring a small volume sealant (e.g., ≥15 mL).

Method using a Zahn viscosity cup may be used to measure the viscosity of the liquid sealant. The Zahn cup #0 is completely lowered below the liquid sealant surface in a beaker. The viscosity cup is lifted out of the sealant and a timer starts. The timer stops when the sealant is completely drained from the viscosity cup. The current viscosity time specification is between 20 to 30 seconds.

### Measuring the Density of the Sealant

The density of the liquid sealant can be measured using a density cup. The empty density cup and lid were measured on an analytical balance which was then tared. After formulation, the sealant was filled to the top of the cup, and a lid with a small hole was placed on top. This allows the sealant to overflow onto the lid and ensures full capacity of the cup. The overflowed sealant is removed with a paper wipe. The weight of fully filled and capped density cup is measured on the tared analytical balance to obtain the sealant's density in pounds per gallon. It is convertible to g/cm³ through calculation.

### Sealant Gel Time

Gel time test is used to estimate whether the sealant is curing within the expected curing profile. If the results are out of the specification target, the concentration of activator would be adjusted. A metal wire, culture test tube, hot water bath, and timer are required to perform the gel test. The metal wire is placed into the culture tube so that a portion remains outside of the tube and is long enough to hold. A culture tube is then filled with sealant. The hot water bath is preferably about 90° C.±1° C. and the tube with sealant is placed into the hot water bath. The water level in the bath should be higher than or equal to the sealant level in the tube to thoroughly heat the sealant. After about 90 seconds the wire is lifted. If the entire tube lifts with the wire, the sealant has cured. If the tube does not lift the sealant has not cured and the wire is placed back into the tube. Then an operator can check every 3 seconds (by lifting the wire) until the sealant has cured and note the time it took for the sealant to cure. The current specification target for gel time of the sealant is 2.5 to 4.5 minutes, although it could be any suitable time.

### Glass Transition Temperature (Tg)

Glass transition temperature (Tg) is the temperature at which the polymer structure transitions from glassy to rubbery. This temperature is evaluated to ensure the mechanical stability of sealant-impregnated graphite at FC operating conditions. A three-point bend test on a dynamic mechanical analyzer (DMA) was performed to determine the Tg of impregnated graphite samples. The procedure is based on ASTM D7028 and ISO 6721 guidelines, but any suitable procedure may be utilized.

A strain-controlled module was used with a heating rate of 2° C./min to increase the temperature from 25° C. to 210° C. According to ASTM D7028, Tan δ peak is defined as Tg in the presented results.

### Sealant Example 1

In a 1000 mL glass beaker equipped with a magnetic stirrer, 325 grams of lauryl methacrylate (LMA), 150 grams of 1,12-dodecanediol dimethacrylate (C₁₂DMA), 150 grams of triethylene glycol dimethacrylate (TEGDMA), and 100 grams of diethylene glycol dimethacrylate (DEGDMA) were mixed. To the agitating clear liquid mixture, 7 grams of trimethylolpropane trimethacrylate (TMPTMA) was added with 2.2 grams of VAZO 64. The mixture kept agitating until it became clear again. The sealant has a density of 0.948 g/cm3 (7.911 lb/gallon), a viscosity of 7.5 cps, and a water content of 0.1%. The sealant cured in water at 90° C. with a gel time of 3 minutes 21 seconds. The hardness of the cured sealant was 65 Shore D.

In this Example, through mixing/separating/recovering experiments of 5 grams of liquid sealant in 500 grams of water, the sealant recovery capability can be determined. The liquid sealant in water quickly separates, and the liquid sealant recovered from the top surface of the water is tested based on the following measurements: (1) Fourier-transform infrared spectroscopy (FT-IR) to confirm that the recovered liquid sealant maintained most or all of its original chemical composition; (2) Karl Fischer Titration to determine the amount of water in the recovered liquid sealant, which was 0.5% by weight; and (3) the gel-time of the recovered sealant, which was stabilized at about 3 minutes 30 seconds in water at 90° C., dropping from 5 minutes 40 seconds in water at 90° C., for the first recovered sample. In addition, the evaluation also included checking the water contamination by the liquid sealant with a water Brix Index (Bx) on a refractometer, wherein the Bx was approximately 0.2-0.3, suggesting 0.2-0.3% of sealant contamination. This contamination level is much lower than the traditional water-soluble sealant can result. The Bx of resin water of traditional sealant can reach 1.5% before water disposal.

### Sealant Example 2

In a 300 mL glass beaker equipped with a magnetic stirrer, 90.0 grams of lauryl methacrylate (LMA), 20.5 grams of 1,12-dodecanediol dimethacrylate (C₁₂DMA), 20.5 grams of triethylene glycol dimethacrylate (TEGDMA), and 58.0 grams of diethylene glycol dimethacrylate (DEGDMA) were mixed. To the agitating clear liquid mixture, 0.95 grams of trimethylolpropane trimethacrylate (TMPTMA), and 0.23 grams of bis (2-methacryloxyethyl) phosphate were added along with 0.57 grams of VAZO 64, and 0.01 grams of Columbia Blue. The mixture kept agitating until it became clear again. The sealant had a density of 0.95 g/cm³ (7.935 lb/gallon), a viscosity of 6.0 cps, cured in water at 90° C. with a gel time of 2 minutes 35 seconds. The hardness of the cured sealant was 70 Shore D.

Two powder aluminum test rings with a porosity of 20% were impregnated with the liquid sealant. The process parameters were as follows: dry vacuum for 6.5 minutes at 0-1 torr, wet vacuum for 10 minutes at 0-1 torr, and cured in water at 94° C. for 6 minutes.

A leak test of the rings was run with an internal pressurization at 50 psi, showing no leak. After being soaked in ethanol and jet fuel at room temperature for two days in reference to MIL-I-17563C, the rings still passed the leak test at 50 psi.

### Sealant Example 3

In a 300 mL glass beaker equipped with a magnetic stirrer, 115.0 grams of lauryl methacrylate (LMA), 10.0 grams of bisphenol A (ethoxylate) 3 dimethacrylate, and 70.0 grams of diethylene glycol dimethacrylate (DEGDMA) were mixed. To the agitating clear liquid mixture, 3.0 grams of trimethylolpropane trimethacrylate (TMPTMA), and 0.29 grams of bis (2-methacryloxyethyl) phosphate were added with 0.6 grams of VAZO 64, 0.6 grams of Tegmer 804S, and 0.01 grams of 2,5-thiophenediylbis (5-tert-butyl-1,3-benzoxazole). The mixture kept agitating until it became clear again. The sealant had a density of 0.945 g/cm³ (7.90 lb/gallon), a viscosity of 7.9 cps, and cured in water at 90° C. with a gel time of 2 minutes 59 seconds. The hardness of the cured sealant was 60 Shore D.

The sealant performance was evaluated with test rings in reference to MIL-STD-276A. There were 16 powder aluminum test rings with a porosity of 20% and 16 poser iron test rings were impregnated with this liquid sealant. The process parameters were as follows: dry vacuum for 6.0 minutes at 0-1 torr, wet vacuum for 6.0 minutes at 0-1 torr, pressure for 6 minutes at 75 psi and cure in water at 94° C. for 6 minutes.

The leak test of rings was run with internal pressurization at 50 psi, showing no leak. The compatibility of sealant was then evaluated with chemicals in reference to MIL-I-17563C. All the rings still passed the leak test at 50 psi.

### Sealant Example 4

In a 300 mL glass beaker equipped with a magnetic stirrer, 94.7 grams of lauryl methacrylate (LMA), 21.5 grams of 1,12-dodecanediol dimethacrylate (C₁₂DMA), 10.0 grams of triethylene glycol dimethacrylate (TEGDMA), 58.0 grams of diethylene glycol dimethacrylate (DEGDMA), and 15.0 grams of bisphenol A epoxy diacrylate were mixed. To the agitating clear liquid mixture, 3.0 grams of trimethylolpropane trimethacrylate (TMPTMA), 0.57 grams of VAZO 64, and 0.01 grams of Columbia Blue were added. The mixture kept agitating until it became clear again. The liquid sealant had a density of 0.95 g/cm³ (7.935 lb/gallon), a viscosity of 7.0 cps, and cured in water at 90° C. with a gel time of 2 minutes 35 seconds. The hardness of the cured sealant was 80 Shore D.

The preliminary liquid sealant performance was evaluated by impregnating one SGL Carbon's Sigrafine HLM rupture 2-inch graphite disc and one Mersen's ISO 2910 2-inch graphite rupture disc. The processing parameters were as follows: dry vacuum for 30 minutes at 0-1 torr, wet vacuum for 30 minutes at 0-1 torr, and pressure at 90 psi for 30 minutes. After impregnation, the discs were rinsed with water shower for 10 seconds. Then the graphite discs were cured in a hot water bath at 94° C. for 6 minutes. The discs showed no leak at the membrane with a biased pressure of 30 psi.

### Sealant Example 5

In a 2000 mL glass beaker equipped with a magnetic stirrer, 560.0 grams of lauryl methacrylate (LMA), 100.0 grams of 1,12-dodecanediol dimethacrylate (C₁₂DMA), 240.0 grams of diethylene glycol dimethacrylate (DEGDMA), and 300.0 grams of bisphenol A ethoxylate dimethacrylate were mixed. To the agitating clear liquid mixture, 3.6 grams of VAZO 64, was added. The mixture kept agitating till it became clear again. The liquid sealant had a density of 0.95 g/cm³ (7.94 lb/gallon), a viscosity of 13.0 cps, and cured in water at 90° C. with a gel time of 2 minutes 45 seconds. The hardness of the cured sealant was 55 Shore D.

The preliminary sealant performance was evaluated by impregnating one SGL Carbon's Sigrafine HLM 2-inch rupture graphite disc and one Mersen's ISO 2910 2-inch graphite rupture disc. The processing parameters were as follows: dry vacuum for 30 minutes at 0-1 torr, wet vacuum for 30 minutes at 0-1 torr, and pressure at 90 psi for 30 minutes. After impregnation, the discs were rinsed with a water shower for 10 seconds. Then the discs were cured in a hot water bath at 94° C. for 6 minutes. The discs showed no leak of the membrane with a biased pressure of 30 psi.

Some non-limiting examples of this disclosure follow.

Example 1: A liquid sealant for use in vacuum pressure impregnation, wherein the sealant includes at least one monomer that is at least partially hydrophilic, at least one monomer that is at least partially hydrophobic, and wherein the sealant has a density less than the density of water.

Example 2: The liquid sealant of example 1 that includes C₁₂-C₁₄ alkyl methacrylate (“LMA”) as a first partially hydrophobic monomer.

Example 3: The liquid sealant of example 1 or example 2 that includes 1, 12 dodecanediol dimethacrylate (“C₁₂DMA”) as a second partially hydrophobic monomer.

Example 4: The liquid sealant of any one of examples 1-3 that includes C₁₆-C₁₈ alkyl methacrylate (“SMA”) as a third partially hydrophobic monomer.

Example 5: The liquid sealant of example 2, wherein the LMA has a density of 0.87 of the density of water.

Example 6: The liquid sealant of example 3, wherein the C₁₂DMA has a density of 0.95 of the density of water.

Example 7: The liquid sealant of example 4, wherein the SMA has a density of 0.86 of the density of water.

Example 8: The liquid sealant of any one of examples 1-7 that includes trimethylolpropane trimethacrylate (“TMPTMA”) as a first, partially hydrophilic monomer.

Example 9: The liquid sealant of example 8, wherein the TMPTMA has a water solubility of 0.01 g/l.

Example 10: The liquid sealant of any one of examples 1-9 that includes triethyleneglycol dimethacrylate (“TEGDMA”) as a second, partially hydrophilic monomer.

Example 11: The liquid sealant of example 10, wherein the TEGDMA has a water solubility of 3.5 g/l.

Example 12: The liquid sealant of any one of examples 1-11 that includes diethyleneglycol dimethacrylate (“DEGDMA”) as a third, partially hydrophilic monomer.

Example 13: The liquid sealant of example 12, wherein the DEGDMA has a water solubility of 0.58 g/l.

Example 14: The liquid sealant of example 8, wherein the TMPTMA has a density of 1.06 times the density of water.

Example 15: The liquid sealant of example 10, wherein the TEGDMA has a density of 1.07 times the density of water.

Example 16: The liquid sealant of example 12, wherein the DEGDMA has a density of 1.06 times the density of water.

Example 17: The liquid sealant of any one of examples 1-16 that has a viscosity of 7.5 cps.

Example 18: The liquid sealant of any one of examples 1-17 that has a density of 0.948 g/cm³.

Example 19: The liquid sealant of any one of examples 1-18 that a hardness of 65 Shore D when cured.

Example 20: The liquid sealant of any one of examples 1-19 that has a density of 1.03/cm³.

Example 21: The liquid sealant of any one of examples 1-20 that includes Vazo 64.

Example 22: The liquid sealant of any one of examples 1-21 that has a gel time of 3 minutes 22 seconds.

Example 23: The liquid sealant of any one of examples 1-22 that is formulated such that 98% or more of the sealant floats to the surface of water at 23° C. after the sealant has been dispersed in of water at 23° C.

Example 24: The liquid sealant of any one of examples 1-23 that can be recycled from the top surface of rinse water and reused up to five times with no loss in curing properties.

Example 25: The liquid sealant of any one of examples 1-24, wherein after being dispersed in water at 23° C., 0.5% or less by weight of the sealant remains dissolved/dispersed in the water 5 minutes after stopping agitation.

Example 26: The liquid sealant of any one of examples 1-25 that is configured to cure in 10 minutes or less after being impregnated in a part and the part is then pressurized and heated in water or steam at 80° C.-100° C.

Example 27: The liquid sealant of any one of examples 1-26 that has a gel time of from 2.8 minutes to 3.5 minutes in a 90° C. water bath.

Example 28: The liquid sealant of example 27 that has a viscosity of 7.5 cps.

Example 29: The liquid sealant of example 2 that includes about 44.4% LMA by weight.

Example 30: The liquid sealant of example 3 that includes about 0.96%

TMPTMA by weight.

Example 31: The liquid sealant of example 10 that includes about 20.49%

TEGDMA by weight.

Example 32: The liquid sealant of example 12 that includes about 13.66% DEGDMA by weight.

Example 33: The liquid sealant of example 12 that includes about 20.49% C₁₂DMA by weight.

Example 34: The liquid sealant of any one of examples 1-33 that is configured to, after recovery from rinse water, be heated to 30° C.-40° C. to expel water.

Example 35: The liquid sealant of any of one of examples 1-33, wherein water can be forced out of the recovered liquid sealant toward which a vacuum of 1-6 torr is applied.

Example 36: The liquid sealant of example 35, wherein the liquid sealant is at a temperature of 30° C.-40° C. when the vacuum of 1-6 torr is applied.

Example 37: The liquid sealant of any one of examples 1-36 that includes a bisphenol A based difunctional acrylic monomer.

Example 38: The liquid sealant of example 37, wherein the bisphenol A based difunctional acrylic monomer is one or more of (a) bisphenol A epoxy diacrylate, (b) bisphenol A (ethoxylated)ₙ diacrylates, n=3, 4, 10, 30, and (c) bisphenol A (ethoxylated), dimethacrylates, n=3, 4, 10, 30.

Example 39: The liquid sealant of example 38 (a), (b), or (c), wherein the bisphenol A based difunctional acrylic monomer has a density of 1.12-1.14 times the density of water.

Example 40: The liquid sealant of any one of examples 1-39 that further comprises bis [2-(meth acryloyloxy) ethyl] phosphate.

Example 41: The liquid sealant of any one of examples 1-40 that further comprises one or more of (a) lauryl ethoxylated acrylate, (b) hexanediol ethoxylated diacrylate, (c) alcohol ethoxylate, or (d) tetraethyleneglycol bis (2-ethylheanoate).

Example 42: The liquid sealant of example 37 that is heat cured, and wherein the bisphenol A based difunctional acrylic monomer(s) used is Vazo 64, and the Vazo 64 is loaded in a weight percentage of 0.25%-0.3% of the liquid sealant.

Example 43: The liquid sealant of any one of examples 1-42 that has a viscosity in the range of 5.0-15.0 cps.

Example 44: The liquid sealant of any one of examples 1-43 that is heat cured and has a gel time at 90° C. from 2 minutes 30 seconds to 4 minutes 30 seconds.

Example 45: The liquid sealant of any one of examples 1-44 that has a hardness in a range of 55-70 Shore D when cured, or a hardness in a range of 55-80 Shore D when cured.

Example 46: The liquid sealant of example 45 that has a solid density of 1.03 g/cm³ when cured.

Example 47: The liquid sealant of any one of examples 1-45 that is configured to cure in 10 minutes or less when heated in water or steam at 80° C.-100° C.

Example 48: The liquid sealant of any one of examples 1-47, wherein 98% or more of the liquid sealant dispersed into rinse water at 23° C., floats to a surface of the rinse water at 23° C. after 2 hours.

Example 49: The liquid sealant of any one of examples 1-48, wherein after the liquid sealant is recovered/removed from rinse water, the water has a Brix Index (“Bx”) of 0.2 to 0.3.

Example 50: The liquid sealant of any one of examples 1-49 that is configured to cure in water at 90° C. with a gel time of 3 minutes 21 seconds.

Example 51: The liquid sealant of example 45, wherein the hardness of the cured sealant is 65 Shore D.

Example 52: The liquid sealant of example 45 wherein the liquid sealant has a density of 0.948 g/cm³ and a viscosity of 7.5 cps.

Example 53: The liquid sealant of any one of examples 1-52 that has a density of 0.95 g/cm³.

Example 54: The liquid sealant of any one of examples 1-53 that has a viscosity of 6.0 cps.

Example 55: The liquid sealant of example 53 or example 54 that cures in water at 90° C. with a gel time of 2 minutes 35 seconds.

Example 56: The liquid sealant of any one of examples 51-54 that has a hardness of 70 Shore D when cured.

Example 57: The liquid sealant of any one of examples 1-56 that has a density of 0.945 b/cm³ and a viscosity of 7.9 cps.

Example 58: The liquid sealant of example 57 that cures in water at 90° C. with a gel time of 2 minutes 59 seconds.

Example 59: The liquid sealant of any one of examples 1-58 that is moved into the porosity of a part by (a) applying a dry vacuum of 0-1 torr for 5-7 minutes to the part, (b) releasing the liquid sealant into the porosity, and applying a wet vacuum of 0-1 torr to the part for 8-11 minutes.

Example 60: The liquid sealant of example 59 that is further moved into the porosity of the part by applying a pressure of 0-90 psi to the porosity after the wet vacuum has been applied.

Example 61: The liquid sealant of example 60, wherein the pressure is 90 psi and is applied for 6 minutes.

Example 62: The liquid sealant of any one of examples 59-61 that is cured in water at 94° C. for 6 minutes.

Example 63: The liquid sealant of any one of examples 1-58 that is moved into the porosity of a part by (a) applying a dry vacuum of 0-1 torr for 30 minutes to the part, (b) releasing the liquid sealant into the porosity, and applying a wet vacuum of 0-1 torr to the porosity for 30 minutes, and then a pressure of 90 psi for 30 minutes.

Example 64: The liquid sealant of example 63, wherein the part is cured in water at 94° C. for 6 minutes, or cured in water at a temperature of 80° C.-100° C. for 10 minutes or less.

Example 65: The liquid sealant of any one of examples 1-58 that is moved into the porosity of a part by (a) applying a dry vacuum of 0-1 torr for 30 minutes to the part, (b) releasing the liquid sealant into the porosity, and apply a wet vacuum of 0-1 torr to the porosity for 30 minutes, rinsing the part in water for 10 seconds, and then cured in water at 94° C. for 6 minutes.

Example 66: The liquid sealant of any one of examples 59-65, wherein the part is comprised of aluminum, graphite, or steel.

Example 67: The liquid sealant of any one of examples 4-66, wherein the SMA has a density of 0.86 of the density of water.

Example 68: The liquid sealant of any one of examples 1-67, wherein the at least one partially hydrophilic monomer comprises trimethylolpropane ethoxylate triacrylate (TMP (EO) 3TA).

Example 69: The liquid sealant of example 68, wherein the TMP (EO) 3TA has a water solubility of 0.88 g/l.

Example 70: The liquid sealant of example 68, wherein the TMP (EO) 3TA has a density of 1.12 times the density of water.

Example 71: The liquid sealant of any one of examples 1-70, wherein a weight ratio of the at least one partially hydrophobic monomer to the at least one partially hydrophilic monomer is from 55:45 to 65:35.

Example 72: The liquid sealant of example 1-71, wherein the at least one partially hydrophobic monomer comprises a weight ratio of LMA or SMA to C₁₂ DMA of 100:0 to 75:25.

Example 73: The liquid sealant of any one of examples 1-72, wherein the at least one partially hydrophobic monomer is fully hydrophobic.

Example 74: The liquid sealant of any one of examples 1-73, wherein the at least one partially hydrophilic monomer is fully hydrophilic.

Example 75: The liquid sealant of any one of examples 37-39, wherein the bisphenol A (ethoxylated), dimethacrylates, n=3, 4, 10, 30 are in the liquid sealant in a weight percentage of 2%-10%.

Example 76: A part impregnated with any of the liquid sealants of examples 1-75.

Example 77: The part of example 76 that is comprised of either metal or graphite. Example 78: The part of example 77 that is comprised of steel or aluminum.

Example 79: The part of any one of examples 76-78 that is washed and/or rinsed after being impregnated with the liquid sealant.

Example 80: The part of any one of examples 76-79, wherein the liquid sealant is cured in the part after the part is impregnated with the liquid sealant.

Example 81: The part of example 80, wherein the liquid sealant is cured by immersing the part in water or steam at 80° C.-100° C.

Example 82: The part of example 80, wherein the liquid sealant is cured by immersing the part in water at 90° C.

Example 83: The part of any one of examples 80-82, wherein the cured sealant has a hardness from 55-80 Shore D, or a hardness from 55-70 Shore D.

Example 84: The part of any one of examples 80-83, wherein the liquid sealant cures in 10 minutes or less when the part is immersed in water or steam at 80° C.-100° C.

Example 85: The part of any one of examples 80-83, wherein the liquid sealant cures in 45 minutes or less when the part is immersed in water or steam at 80° C.-100° C.

Example 86: The part of example 79, wherein at least some of the liquid sealant washed and/or rinsed from the part is dispersed in the wash water and/or rinse water and floats to the top surface of the wash water and/or rinse water and is removed from the wash water and/or rinse water.

Example 87: The part of example 86, wherein when the wash water and/or rinse water is at 23° C., 50% of the liquid sealant dispersed in the wash water and/or rinse water floats to the top surface of the wash water and/or rinse water 1 minute after being dispersed.

Example 88: The part of any one of examples 86-87, wherein when the wash water and/or rinse water is at 23° C., 60% of the liquid sealant dispersed in the wash water and/or rinse water floats to the top surface of wash water and/or rinse water 2 minutes after being dispersed.

Example 89: The part of any one of examples 86-88, wherein when the wash water/rinse water is at 23° C., 90% of the liquid sealant dispersed in the wash water and/or rinse water floats to the top surface of the wash water/rinse water 10 minutes after being dispersed.

Example 90: The part of any one of examples 86-89, wherein when the wash water/rinse water at 23° C., more than 90% of the liquid sealant in the wash water and/or rinse water floats to the top surface of the wash water/rinse water 1 hour after being dispersed.

Example 91: The part of any one of examples 86-90, wherein after 90% or more of the liquid sealant has been collected from the wash water and/or rinse water, the wash water and/or rinse water has a Brix index (Bx) of 0.2-0.3.

Example 92: The part of any one of examples 86-91, wherein the recovered liquid sealant is tested for being suitable for reuse.

Example 93: The part of example 92, wherein the recovered liquid sealant is tested for one or more viscosity, gel time, and mechanical strength.

Example 94: The part of example 93, wherein the recovered liquid sealant is deemed unsuitable for reuse of its viscosity is not within a liquid sealant viscosity range of 5-15 cps at 25° C.

Example 95: The part of any one of examples 92-94, wherein the recovered liquid sealant is deemed unsuitable for reuse if the gel time in water at 90° C. is more than 6 minutes, outside of the sealant's specification range.

Example 96: The part of any one of examples 92-95, wherein the recovered liquid sealant is deemed unsuitable for reuse if it has a cured hardness of less than 50 Shore D.

Having thus described some embodiments of the invention, other variations and embodiments that do not depart from the spirit of the invention will become apparent to those skilled in the art. The scope of the present invention is thus not limited to any particular embodiment but is instead set forth in the appended claims and the legal equivalents thereof. Unless expressly stated in the written description or claims, the steps of any method recited in the claims may be performed in any order capable of yielding the desired result.

What is claimed is:

1. A liquid sealant for use in vacuum pressure impregnation, wherein the sealant includes at least one monomer that is at least partially hydrophilic, at least one monomer that is at least partially hydrophobic, and wherein the sealant has a density less than the density of water.

2. The liquid sealant of claim 1 that includes C₁₂-C₁₄ alkyl methacrylate (LMA) as a partially hydrophobic monomer.

3. The liquid sealant of claim 1 that includes 1, 12-dodecane diol dimethacrylate (C₁₂DMA) as a partially hydrophobic monomer.

4. The liquid sealant of claim 2, wherein the LMA has a density of 0.87 of the density of water.

5. The liquid sealant of claim 3, wherein the C₁₂DMA has a density of 0.95 of the density of water.

6. The liquid sealant of claim 1 that includes trimethylolpropane trimethacrylate (TMPTMA) as a partially hydrophilic monomer.

7. The liquid sealant of claim 6, wherein the TMPTMA has a water solubility of 0.01 g/l.

8. The liquid sealant of claim 1 that includes triethyleneglycol dimethacrylate (TEGDMA) as a partially hydrophilic monomer.

9. The liquid sealant of claim 8, wherein the TEGDMA has a water solubility of 3.5 g/l.

10. The liquid sealant of claim 1 that includes diethyleneglycol dimethacrylate (DEGDMA) as a partially hydrophilic monomer.

11. The liquid sealant of claim 10, wherein the DEGDMA has a water solubility of 0.58 g/l.

12. The liquid sealant of claim 1 that includes bisphenol A ethoxylated dimethacrylate as a partially hydrophilic monomer.

13. The liquid sealant of claim 12, wherein the bisphenol A ethoxylated dimethacrylate has a very low solubility in water.

14. The liquid sealant of claim 1 that includes bis [2-(meth acryloyloxy) ethyl] phosphate as a hydrophilic monomer and adhesion promoter.

15. The liquid sealant of claim 14, wherein the bis [2-(meth acryloyloxy) ethyl] phosphate is soluble in water.

16. The liquid sealant of claim 1 that has a viscosity of 6.5-12.0 cps at 23° C.

17. The liquid sealant of claim 1 that has a density of 0.930-0.955 g/cm³.

18. The liquid sealant of claim 1 that a hardness of 60-75 Shore D when cured.

19. The liquid sealant of claim 1 that has a density of 1.02-1.05 g/cm³.

20. The liquid sealant of claim 1 that is formulated such that 98% or more of the sealant floats to the surface of water at 23° C. within 2 hours after the sealant is dispersed in water at 23° C.

21. The liquid sealant of claim 1 that can be recycled and reused up to five times while maintaining sufficient curing properties for a part in which the liquid sealant is impregnated.

22. The liquid sealant of claim 1, wherein after being dispersed in water at 23° C., 0.5% or less by weight of the sealant remains dispersed in the water at 23° C. after 5 minutes.

23. The liquid sealant of claim 1 that includes a radical initiator.

24. The liquid sealant of claim 1 that is configured to cure in 10 minutes or less after being impregnated in a part and the part is then placed in hot water or steam at 80° C.-100° C.

25. The liquid sealant of claim 1 that has a viscosity from 5.0-15.0 cps at 23° C.

26. The liquid sealant of claim 1 that has a gel time of from 2.5 minutes to 4.0 minutes in a 90° C. water bath.

27. A part impregnated with the liquid sealant of claim 1, wherein the part is comprised of metal or graphite.

28. The part of claim 24 that is cured in 10 minutes or less when immersed in water at 80° C.-100° C.
